(19) United States
(12) Patent Application Publication
(10) Pub. No.: US 2006/0051628 A1
(43) Pub. Date: Mar. 9, 2006

(54) Diagnostic method for an electrochemical fuel cell and fuel cell components

(76) Inventors: Chuey-Yeng Lim, Burnaby (CA); Herwig R. Haas, Vancouver (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/935,723

(22) Filed: Sep. 7, 2004

(51) Int. Cl. H01M 8/00

(52) U.S. Cl. 429/13

(57) ABSTRACT

A diagnostic method for an electrochemical fuel cell is described wherein a non-steady state polarization curve is obtained. In particular, a current sweep is applied to, for example, a catalyst coated membrane (CCM), membrane electrode assembly (MEA), fuel cell, plurality of fuel cells and the resulting voltage obtained is recorded. At low current densities, the ramp rate may be relatively slow and relatively fast at higher current densities. The ramp rate may increase in discrete steps or continuously throughout the current sweep. A polarization curve of voltage as a function of current may thus be obtained with the entire current sweep lasting less than 20 seconds and more.

### BACKGROUND OF THE INVENTION

1. Field of the Invention

The present invention relates to a diagnostic method related to electrochemical fuel cells and fuel cell components and more particularly to a diagnostic method to measure polarization curves for an electrochemical fuel cell or fuel cell component.

2. Description of the Related Art

Electrochemical fuel cells convert reactants, namely fuel and oxidant fluid streams, to generate electric power and reaction products. Electrochemical fuel cells employ an electrolyte disposed between two electrodes, namely a cathode and an anode. The electrodes each comprise an electrocatalyst disposed at the interface between the electrolyte and the electrodes to induce the desired electrochemical reactions. The location of the electrocatalyst generally defines the electrochemically active area.

Polymer electrolyte membrane (PEM) fuel cells generally employ a membrane electrode assembly (MEA) consisting of an ion-exchange membrane disposed between two electrode layers comprising porous, electrically conductive sheet material as fluid diffusion layers, such as carbon fiber paper or carbon cloth. In a typical MEA, the electrode layers provide structural support to the ion-exchange membrane, which is typically thin and flexible. The membrane is ion conductive (typically proton conductive), and also acts as a barrier for isolating the reactant streams from each other. Another function of the membrane is to act as an electrical insulator between the two electrode layers. The electrodes should be electrically insulated from each other to prevent short-circuiting. A typical commercial PEM is a sulfonated perfluorocarbon membrane sold by E.I. Du Pont de Nemours and Company under the trade designation NAFION®.

The MEA contains an electrocatalyst, typically comprising finely comminuted platinum particles disposed in a layer at each membrane/electrode layer interface, to induce the desired electrochemical reaction. The electrodes are electrically coupled to provide a path for conducting electrons between the electrodes through an external load.

In a fuel cell stack, the MEA is typically interposed between two separator plates that are substantially impermeable to the reactant fluid streams. The plates act as current collectors and provide support for the electrodes. To control the distribution of the reactant fluid streams to the electrochemically active area, the surfaces of the plates that face the MEA may have open-faced channels formed therein. Such channels define a flow field area that generally corresponds to the adjacent electrochemically active area. Such separator plates, which have reactant channels formed therein are commonly known as flow field plates. In a fuel cell stack a plurality of fuel cells are connected together, typically in series, to increase the overall output power of the assembly. In such an arrangement, one side of a given plate may serve as an anode plate for one cell and the other side of the plate may serve as the cathode plate for the adjacent cell. In this arrangement, the plates may be referred to as bipolar plates.

The fuel fluid stream that is supplied to the anode typically comprises hydrogen. For example, the fuel fluid stream may be a gas such as substantially pure hydrogen or a reformate stream containing hydrogen. Alternatively, a liquid fuel stream such as aqueous methanol may be used. The oxidant fluid stream, which is supplied to the cathode, typically comprises oxygen, such as substantially pure oxygen, or a dilute oxygen stream such as air. In a fuel cell stack, the reactant streams are typically supplied and exhausted by respective supply and exhaust manifolds. Manifold ports are provided to fluidly connect the manifolds to the flow field area and electrodes. Manifolds and corresponding ports may also be provided for circulating a coolant fluid through interior passages within the stack to absorb heat generated by the exothermic fuel cell reactions. The preferred operating temperature range for PEM fuel cells is typically 50° C. to 120° C., most typically between 75° C. and 85° C.

Typically, a current-voltage polarization curve is recorded as a diagnostic tool to evaluate fuel cell performance. For example, in WO 04/030119 the current output from an individual fuel cell was recorded as the voltage was stepped down in 50 mV steps starting from the open circuit voltage (OCV) down to 0.15 V and then back up to the OCV. The voltage was held constant at each step for 20 seconds to allow for the current output from the cell to stabilize. In U.S. Patent Application No. 2004/0443271, polarization curves were measured by recording the voltage as the current density was stepped up from 0 to 1000 mA/cm² in steps of 50 to 200 or more mA/cm². While both methods of obtaining polarization curves yield useful information about the health of the fuel cell studied, they are time consuming and imprecise. For example, typical polarization curves may take hours to complete and are unable to resolve differences of 10 to 30 mV.

Accordingly, there remains a need in the art for improved diagnostic methods for obtaining polarization curves for electrochemical fuel cells. The present invention fulfills this need and provides further related advantages.

### BRIEF SUMMARY OF THE INVENTION

The present invention is directed to a diagnostic method for an electrochemical fuel cell component wherein a non-steady state polarization curve is obtained. Suitable fuel cell components include a catalyst coated membrane (CCM), membrane electrode assembly (MEA), fuel cell, and plurality of fuel cells. In an embodiment, the diagnostic method comprises the steps of providing an electrochemical fuel cell component, applying oxidant and fuel to the fuel cell component and applying a current sweep to the fuel cell component. The voltage output from the electrochemical fuel cell component may then be recorded. In a further embodiment, the recorded voltage is plotted as a function of current to obtain a polarization curve.

In an embodiment, the current sweep may have multiple ramp rates over the duration of the current sweep. The current ramp rate is the rate at which the current increases during the current sweep. A suitable current sweep is from 0 to 2 A/cm². In an embodiment, the initial ramp rate is smaller than the final ramp rate. In certain embodiments, the ramp rate may increase in discrete steps over the duration of the current sweep for example with at least 2 different ramp rates being used, more particularly with at least 4 different ramp rates used and even more particularly with 6 different ramp rates used. In other embodiments, the ramp rate may increase continuously over the duration of the current sweep, for example substantially exponentially. Additional profiles for the current sweep are envisaged wherein the ramp rate increases both continuously for a portion of the sweep and in discrete steps for other portions of the current sweep.

The present embodiments allow for polarization curves to be obtained relatively quickly. For example, the current sweep may be applied to the fuel cell component for only between 5 and 20 seconds and more particularly for between 8 and 12 seconds. This compares very favorably with prior art methods of obtaining a steady state polarization curve.

These and other aspects of the invention will be evident upon reference to the attached figures and following detailed description.

### BRIEF DESCRIPTION OF THE DRAWINGS

FIG. 1 is a polarization curve of voltage as a function of current for an electrochemical fuel cell as performed using conventional methods.

FIG. 2 is a polarization curve of voltage as a function of current for an electrochemical fuel cell performed under non-steady state conditions.

FIG. 3 is a graph of current and voltage as a function of time for an electrochemical fuel cell.

FIG. 4 is the polarization curve of voltage as a function of current for the electrochemical fuel cell of FIG. 3.

FIG. 5 is a polarization curve of voltage as a function of current comparing two different MEAs.

FIG. 6 is a simplified schematic of the system used to perform the polarization curve of FIGS. 4 and 5.

### DETAILED DESCRIPTION OF THE INVENTION

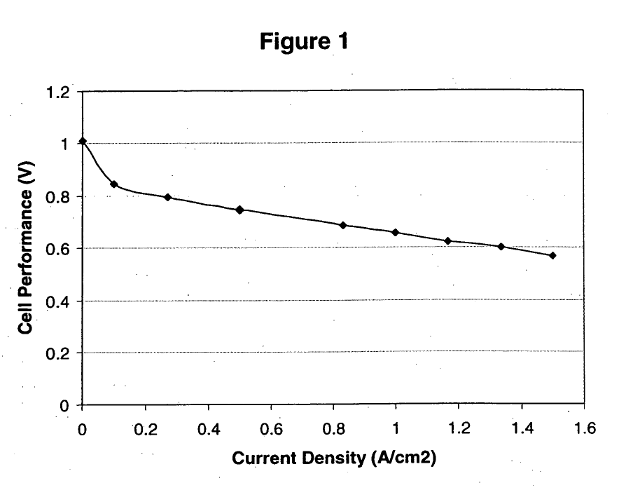

FIG. 1 is a polarization curve of voltage as a function of current for an electrochemical fuel cell as performed using conventional methods. In particular, polarization curves were measured by recording the voltage as the current density was stepped up from 0 to 1.5 mA/cm² in steps of 100 to 200 or more mA/cm². At each step, the voltage is allowed to stabilize in order to obtain a steady state measurement. This can lead to long testing times of several hours or even longer. The long testing times may also introduce additional errors. For example, in a polarization curve as shown in FIG. 1, an assumption is made that the water and current distributions within the fuel cell remain constant over the duration of the test. However, this assumption may not be accurate when the duration of the test takes such a long time. In addition, the relatively small data set means that accuracy is compromised in any polarization curve. Differences of 10 to 30 mV may be difficult or even impossible to resolve.

In the present application, a non-steady state polarization curve is obtained. In particular, a current sweep is applied to a fuel cell while recording the voltage response. A suitable current sweep would be from 0 to 2 A/cm². However, different effects may be seen if the current sweep is either too fast or too slow. For example, the membrane electrode assembly (MEA) may act as a capacitor if the current sweep is too fast. Without being bound by theory, the system may not be given enough time to discharge with a fast current sweep and the observed voltage will reflect both the fuel cell voltage and the excess discharge. However if the current sweep is too slow, then the local supply of reactants may be depleted thereby reducing the observed voltage. In other words, the observed voltage may be limited by the diffusion of new reactants to the catalyst layer. This latter effect is also known as mass transport losses.

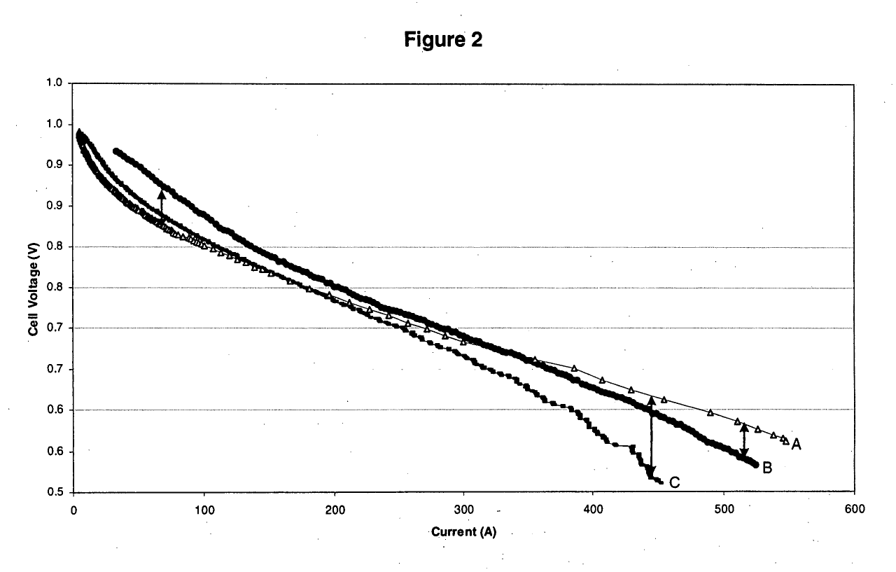

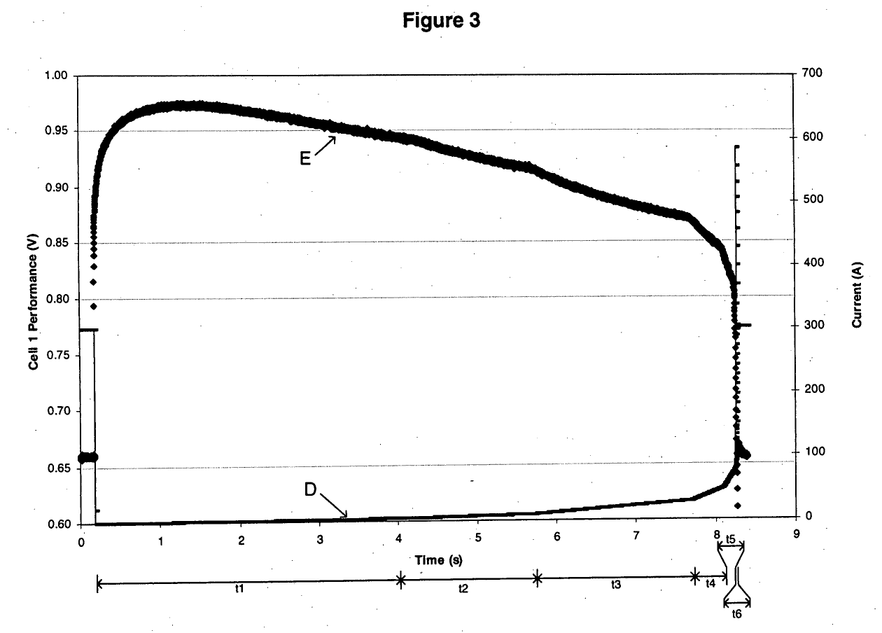

FIG. 2 shows 3 non-steady state polarization curves, namely curves A, B and C. Curve A shows the polarization curve obtained with a variable current ramp rate. At low current values, the current ramp rate was increased slowly and at high currents, the current ramp rate was increased much more quickly. More detail on the current ramp profile is discussed below with respect to FIG. 3. The current used in FIG. 2 can be easily converted to current density by dividing by the active area of the MEA tested, namely 300 cm² for the fuel cell used in FIG. 2.

In comparison, curves B and C show the resulting effects of using constant ramp profiles. In curve B, the current was swept from 0 to 600 A in 0.2 seconds to give a constant ramp rate of 3000 A/s (the fast current ramp profile). In comparison, for curve C, the current was swept from 0 to 600 A in 10 seconds to give a current ramp rate of 60 A/s (the slow current ramp profile). At low current densities, the slow current ramp rate as shown in curve C closely matches the variable ramp profile as shown in curve A. In comparison, the fast current ramp as shown in curve B shows a significantly higher voltage at the same current. As discussed above, this is believed to be due to discharge effects though other effects may be responsible for the higher observed voltages at low current densities. Regardless of the underlying cause, ramp rates that are too high lead to artifacts being observed in the resulting polarization curve at low current densities.

At high current densities, voltage losses were observed for both the fast current ramp curve B and the slow current ramp curve C. As discussed above, this is believed to be due to mass transport losses and can be reduced or even eliminated by increasing the current ramp rate to a value even higher than 3000 A/s as used for curve B. While polarization curves can be obtained with constant ramp rates, the use of a variable ramp rate allows for the different effects seen at different current densities to be reduced or eliminated.

FIG. 3 shows an empirically determined current ramp profile for an electrochemical fuel cell. The measured cell was cell 1 of a 10 cell stack (Pₒₓ/P_{fuel}=30 psig; Fuel flow=40 slpm; Oxidant flow=125 slpm; Temperature at inlet=60° C.). With multiple ramp profiles, the change in current may be slow enough at low currents to allow discharging of the MEA capacitance while fast enough at the high currents to prevent or reduce reactant depletion. Line D shows the change in current as a function of time. 6 different ramp rates were used as shown as times t1-t6 as the current was increased from 0 to about 600 A (0-2 A/cm²). An exponential increase in current is approximated from the different ramp rates. Line E shows the measured voltage for the MEA as the current was increased.

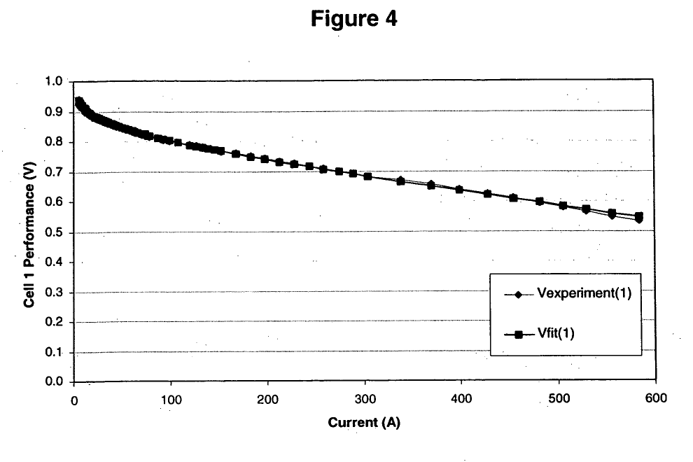

FIG. 4 shows the corresponding polarization curve from FIG. 3 where voltage is plotted as a function of current (shown as Vexperiment(1)). While the current sweep in FIG. 3 took only approximately 8 seconds to complete, approximately 5000 data points were able to be collected. This is a significant improvement on conventional techniques that may take hours to complete while only obtaining on the order of 10 data points.

In the present polarization curve, the ramp rate was fast enough at high currents that it was assumed that there is no or minimal reactant depletion. Such polarization curves demonstrate a mass transport free performance and can provide useful information about the fuel cell. They can also be used in conjunction with other techniques if mass transport losses in the fuel cell want to be examined. Further, 6 different ramp rates were considered to be adequate to obtain good results. In other applications, the ramp rate may increase continuously and exponentially throughout the current sweep. In such an embodiment, the ramp rate at any point in time is the slope of the curve of current as a function of time. Satisfactory results may also be observed with fewer than the 6 discrete ramp rates shown in FIG. 4. For example 3 or 4 ramp rates may be used with satisfactory results depending on the purpose of the polarization curve. In some applications, using 2 current ramp rates with only a slow and a fast ramp rate may be sufficient.

Without being bound by theory, the cell voltage can generally be written as a reversible potential minus loss terms, as follows:
E_{cell}=Eₑ−η_{c}−ηₐ−iR_{cell} (1)
where Eₑ is the equilibrium voltage; η_{c} and ηₐ are the cathode and anode overpotentials, respectively; i is the current density; and R_{cell} is the area resistance (Ωcm²).

The iR_{cell} term in equation 1 is the ohmic resistance. Although R_{cell} is the total ohmic resistance of the cell, it can be assumed that membrane resistance dominates for relatively thick membranes and that any change in R_{cell} is due to the membrane. In such a case, dividing R_{cell} by the membrane thickness gives an approximate value for the membrane resistance. When thin membranes are used, other fuel cell components may play a significantly larger role in the measurement of R_{cell}, such that membrane resistance no longer dominates.

The electrode overpotentials, η_{c} and ηₐ, are related exponentially to the current i as provided in both the Butler-Volmer and the Tafel equations. Thus, in addition to the ohmic resistance of the cell, polarization curves can also be analyzed to examine the relationship between current, voltage and reactant concentration for the cell.

For example, in FIG. 4, a polarization curve of the present invention was fitted to equation 1 modified by the Tafel and Butler-Volmer equations. The fitted curve is shown as in FIG. 4 as Vfit(1). As can be seen in FIG. 4, the fitted curve showed a good correlation with the observed polarization curve. The ohmic resistance of the cell was then determined to be 0.149 Ωcm².

A further advantage of using non-steady state polarization curves is the relative speed. Being able to obtain a useful polarization curve in less than 10 seconds instead of over several hours using steady state conditions not only greatly reduces the resources needed to obtain a polarization curve but also allows new MEAs to be tested.

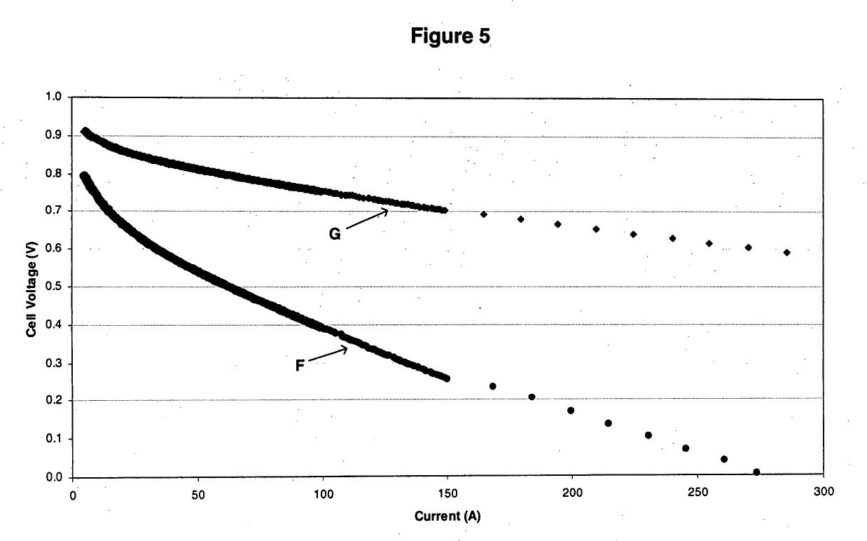

It is well known that the performance of an MEA increases significantly after it is first manufactured and does not stabilize until after approximately 12 hours of operation. This may be referred to as a conditioning step typically performed on new MEAs to produce conditioned MEAs. It is not known exactly why this is seen though it may be due to increased hydration of the membrane and/or removal of oxides from the catalyst in the new MEA. FIG. 5 shows the polarization curves of a new MEA shown as curve F and the same MEA after operation at 300 A for 12 hours as curve G. The polarization curve was obtained for cell 6 in a 10 cell stack and the expected improvement in performance is clearly seen between the new MEA in curve F and the conditioned MEA in curve G.

For the purposes of the present invention, a particularly interesting feature of FIG. 5 is that a polarization curve was obtained for a new MEA. This could not be done using traditional diagnostic methods as the performance of the MEA would change during the course of the measurement. In other words, the present methods allow useful information about the MEA to be determined without necessarily subjecting the MEA to a conditioning step. The present methods could thus be used as quality control in ex situ testing to quickly ensure that supplied MEAs possess basic functionality and/or fall within tolerances developed for the MEA.

The performance of the new MEA may also be directly related to the performance of the conditioned MEA. If so, the present method may be a useful tool in material development to quickly compare different MEAs without having to perform a conditioning step on them.

The polarization curves of the present invention can be used to compare different MEAs, different cell designs, different oxidants, flow rates, temperature, other operating conditions, etc. The polarization curve of the present invention can also be used on a variety of different electrochemical fuel cell components. For example, polarization curves can be obtained from complete fuel cells having flow fields and MEAs, multiple fuel cells in a fuel cell stack or just the MEA itself including partial MEAs or CCMs. Problems with the MEA or components thereof can thus be identified at an early stage without having to build and run complete fuel cells individually or within an electrochemical fuel cell stack. Such polarization curves may also be used as a quality control tool in large scale manufacturing of both electrochemical stacks or components thereof.

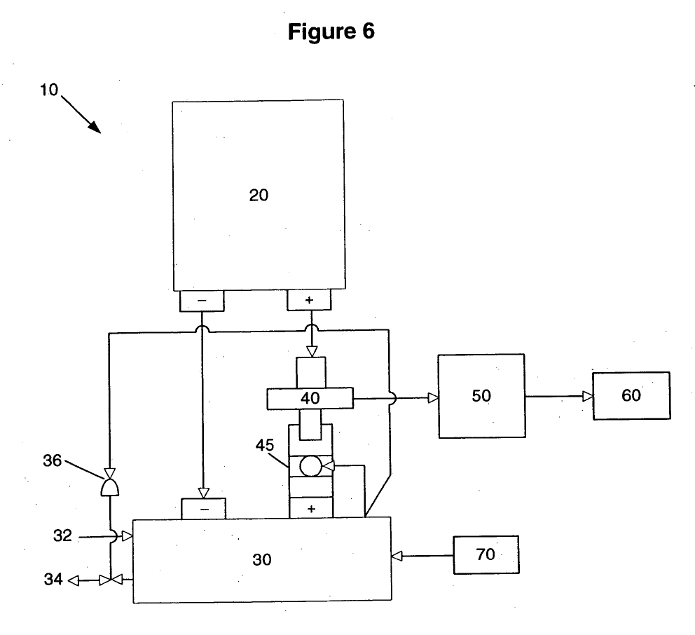

FIG. 6 is a simplified schematic of an embodiment of a system 10 used to measure a polarization curve of a fuel cell stack 20 using a variable ramp rate for the current. The negative pole of stack 20 is connected directly to loadbank 30. Loadbank 30 is a programmable loadbank capable of pulling a load from stack 20. A suitable loadbank is commercially available from Transistor Devices, Inc (TDI) as part no. WCL 488 50-1200-12000. A water coolant inlet 32 and outlet 34 and control valve 34 may be used to regulate the temperature of loadbank 30. The positive pole of stack 20 is connected to loadbank 30 through current transducer 40 and DC contactor 45. While many loadbanks may be able to measure the current as well as pull a load on the stack, current transducer 40 allows a more accurate measurement of the current from stack 20. The measured current is then fed through a current transmitter electronics board 50 which converts the output to a 0 to +/−10 VDC output and which may be monitored and/or recorded by a data measuring system 60. Data measuring system 60 may be, for example, an oscilloscope or other device with a response fast enough to measure the current response which may, for example, be on the order of 1000 Hz. Control system 70 provides the input to control loadbank 30 and may comprise, for example, a PC computer.

From the foregoing, it will be appreciated that, although specific embodiments of the invention have been described herein for purposes of illustration, various modifications may be made without deviating from the spirit and scope of the invention. Accordingly, the invention is not limited except as by the appended claims.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

What is claimed is:

1. A diagnostic method for an electrochemical fuel cell component comprising:
providing the electrochemical fuel cell component;
applying oxidant and fuel to the fuel cell component;
applying a current sweep to the fuel cell component; and
recording the voltage output from the electrochemical fuel cell component.

2. The diagnostic method of claim 1 further comprising plotting the recorded voltage as a function of current to obtain a polarization curve.

3. The diagnostic method of claim 1 wherein the current sweep comprises multiple ramp rates over the duration of the current sweep.

4. The diagnostic method of claim 3 wherein the initial ramp rate is smaller than the final ramp rate.

5. The diagnostic method of claim 4 wherein the ramp rate increases in discrete steps over the duration of the current sweep.

6. The diagnostic method of claim 5 wherein at least 2 different ramp rates are used.

7. The diagnostic method of claim 6 wherein at least 4 different ramp rates are used.

8. The diagnostic method of claim 7 wherein 6 different ramp rates are used.

9. The diagnostic method of claim 4 wherein the ramp rate is continuously increasing over the duration of the current sweep.

10. The diagnostic method of claim 9 wherein the ramp rate increases substantially exponentially over the duration of the current sweep.

11. The diagnostic method of claim 1 wherein the current sweep is from 0 to 2 A/cm².

12. The diagnostic method of claim 1 wherein the applying a current sweep step lasts for between 5 and 20 seconds.

13. The diagnostic method of claim 12 wherein the applying a current sweep step lasts for between 8 and 12 seconds.

14. The diagnostic method of claim 1 wherein the oxidant is air.

15. The diagnostic method of claim 1 wherein the fuel cell component comprises an electrochemical fuel cell.

16. The diagnostic method of claim 15 wherein the fuel cell component comprises a plurality of electrochemical fuel cells.

17. The diagnostic method of claim 1 wherein the fuel cell component is a membrane electrode assembly.

18. The diagnostic method of claim 1 wherein the fuel cell component is a catalyst coated membrane comprising an ion-exchange membrane coated with an anode catalyst layer on one planar surface and a cathode catalyst layer on the opposite planar surface.
